(19) United States
(12) Patent Application Publication
(10) Pub. No.: US 2017/0190272 A1
(43) Pub. Date: Jul. 6, 2017

(54) Protective Seat Cover

(71) Applicant: RON GELLIS, MARLBORO, NJ (US)

(72) Inventor: RON GELLIS, MARLBORO, NJ (US)

(21) Appl. No.: 15/394,737

(22) Filed: Dec. 29, 2016

Related U.S. Application Data
(60) Provisional application No. 62/272,540, filed on Dec. 29, 2015.

(51) Int. Cl. B60N 2/58; A47C 31/11

(52) U.S. Cl. CPC B60N 2/5816; A47C 31/11

(57) ABSTRACT

A protective seat cover for covering a chair seat is provided. The chair seat has a substantially horizontal seat section with a front edge and a back edge and a substantially vertical backrest section. The protective seat cover comprises a germ impervious sheet of material having a top surface, a bottom surface, a top edge, a bottom edge, a first side edge, and a second side edge. A seat receiving pocket is formed at the top edge of the sheet of material. The seat receiving pocket receives and encompasses at least a portion of the top edge of the backrest of the chair seating. The sheet of material is positionable on the chair seating with the bottom surface positioned in a generally downward direction directly against the chair seating and the top surface positioned in a generally upward direction providing a barrier for a contaminated or dirty chair seat.

### CLAIM OF PRIORITY

This patent application claims priority under 35 USC 119 (e) (1) from U.S. Provisional Patent Application Ser. No. 62/272,540 filed Dec. 29, 2015, of common inventorship herewith entitled, “Germ B Gone Seat Cover,” which is incorporated herein by reference as though the same were set forth in its entirety.

### FIELD OF THE INVENTION

The present invention pertains to the field of public seating, and more specifically to the field of seat covers.

### BACKGROUND OF THE INVENTION

Millions of Americans regularly utilize public transportation. Whether a suburbanite commuting by train to the office, a city dweller traveling regularly by subway or a college coed using on a local bus line for weekend visits with family, public transportation provides an affordable and reliable way in which to get from one place to another place both safely and easily. Particularly useful for people who live in crowded cities, using public transportation is a practical alternative to owning a personal automobile which is costly to park and expensive to maintain. Many individuals find that taking public transportation is also a simple way in which they can do their part to protect the environment. Riding a bus or hopping on a subway instead of driving one's vehicle not only saves fuel but also reduces the amount of harmful exhaust emissions that infiltrate the earth's fragile atmosphere.

While there is little dispute that public transportation is a practical necessity, there are some drawbacks associated with traveling in this manner. Specifically, because public transportation seats are utilized by so many people, their surfaces are extremely unsanitary. Utilized by literally dozens of people throughout the day, public seats often are covered in loose hairs, flakes of dead skin and other tiny particles that are easily passed between commuters. Anyone who regularly travels by air or commutes by bus readily attests that coming into contact with a seat sullied with detritus, dirt and other debris is a fairly common occurrence when utilizing public transportation. Arriving to work only to realize that one has sat in a spilled beverage and the remains are all over the back of one's pants or skirt, is rather frustrating and embarrassing.

In addition to sullying clothing, dirt and other debris that linger on a public seat are rife with germs and bacteria that are easily transferred to a commuter's body by means of simply sitting on the seat. Bringing home an unfortunate flu bug because one has utilized public seating is a problem most commuters would rather do without. This type of cross contamination occurs when utilizing seating at public venues such as movie theaters, concert halls and sports arenas, rendering a person susceptible to a plethora of harmful agents every time they leave their home.

The prior art has put forth several designs for seat covers. Among these are:

US Patent 2014/0117730 to Myra Olive Hoefer describes a removable slipcover for a chair on a mobility device such as a mobility scooter or rolling assembly. The slipcover fits over a seat, chair back and arms and requires no attachment straps or elastic means for retention. The slipcover includes a skirt portion that aids in concealing the chair post of the mobility scooter without extending to or interfering with the wheels of the mobility scooter or rolling assembly. The slipcover includes cushioning on the seat portion for added comfort and pockets for added carrying or storage capability. The slipcover includes ornamentation for aesthetic or advertising purposes. A matching cover for a steering column is included if desired.

US Patent Publication 2013/0320720 to Mary D. Steinmetz describes a form fitting protective seating cover which protects seating features such as headrests, backs and chair surfaces. The protective seating cover includes surfaces for the display of promotions and advertising content. The seating cover is structurally designed for numerous types of row based seating arrangements to take advantage of these unique properties. The seating cover is further constructed to be protective, disposable, biodegradable and customizable for specific seat dimensions, lighting needs and color themes.

U.S. Pat. No. 7,695,066 to Renee D. Guercia and Suzette A. Guercia describes a single use disposable sanitary cover that temporarily houses a portion of a seat and mitigates virus and germ contact on a person's body. The disposable sanitary cover includes a flexible elongated sleeve having an outer shell, an interior cavity and an elongated slit forming a rim equipped with a stabilizing means integrally associated therewith. The stabilizing means is preferably an elastic band or segment that engages with the rear of the back support and seat areas of the chair to secure the elongated sleeve in place. The seat area and back support area of the chair is received through the elongated slit and is housed within the elongated sleeve in order to mitigate contact between the chair surface and a person's body.

U.S. Pat. D469,999 to Kevin R. Christoffersen shows an ornamental design for disposable seat cover.

None of these prior art references describe the present invention.

### SUMMARY OF THE INVENTION

It is an object of the present invention to provide a disposable protective plastic covering configured particularly for use on public seating such as seats found on airplanes, buses, movie theaters, concert venues and sports arenas, for example.

The present invention is a protective seat cover for covering a chair seat. The chair seat has a substantially horizontal seat section with a front edge and a back edge and a substantially vertical backrest section with a top edge and a bottom edge with the backrest section rises from the seat section with the bottom edge of the backrest section positioned adjacent the back edge of the seat section. The protective seat cover comprises a germ impervious sheet of material having a top surface, a bottom surface opposite the top side, a top edge, a bottom edge opposite the top edge, a first side edge between the top edge and the bottom edge, and a second side edge opposite the first side edge. A seat receiving pocket is formed at the top edge of the sheet of material. The seat receiving pocket is sized and shaped for receiving and encompassing at least a portion of the top edge of the backrest of the chair seating. The sheet of material is positionable on the chair seating with the bottom surface positioned in a generally downward direction directly against the chair seating and the top surface positioned in a generally upward direction providing a barrier for a contaminated or dirty chair seat.

In addition, the present invention further includes a method for covering a chair seat. The chair seat has a substantially horizontal seat section with a front edge and a back edge and a substantially vertical backrest section with a top edge and a bottom edge with the backrest section rises from the seat section with the bottom edge of the backrest section positioned adjacent the back edge of the seat section. The method comprises providing a germ impervious sheet of material having a top surface, a bottom surface opposite the top side, a top edge, a bottom edge opposite the top edge, a first side edge between the top edge and the bottom edge, and a second side edge opposite the first side edge, forming a seat receiving pocket at the top edge of the sheet of material, positioning the sheet of material on the chair seating with the bottom surface positioned in a generally downward direction directly against the chair seating and the top surface positioned in a generally upward direction, encompassing at least a portion of the top edge of the backrest of the chair seating with the seat receiving pocket, providing a barrier for a contaminated or dirty chair seat.

The present invention further includes a protective seat cover for covering a chair seat. The chair seat has a substantially horizontal seat section with a front edge and a back edge and a substantially vertical backrest section with a top edge and a bottom edge with the backrest section rises from the seat section with the bottom edge of the backrest section positioned adjacent the back edge of the seat section. The protective seat cover comprises a germ impervious sheet of material having a top surface, a bottom surface opposite the top side, a top edge, a bottom edge opposite the top edge, a first side edge between the top edge and the bottom edge, and a second side edge opposite the first side edge. A seat receiving pocket is formed at the top edge of the sheet of material with the seat receiving pocket having a first side portion secured along the first side edge nearingly adjacent the top edge and a second side portion secured along the second side edge nearingly adjacent the top edge. The seat receiving pocket is sized and shaped for receiving and encompassing at least a portion of the top edge of the backrest of the chair seating. An elastic band releasably secures the sheet of material to the chair seating thereby inhibiting the sheet of material from moving or becoming dislodged from the chair seating. The sheet of material is positionable on the chair seating with the bottom surface positioned in a generally downward direction directly against the chair seating and the top surface positioned in a generally upward direction providing a barrier for a contaminated or dirty chair seat.

### BRIEF DESCRIPTION OF THE DRAWINGS

FIG. 1 is a perspective view illustrating a protective seat cover, constructed in accordance with the present invention, installable on a chair seat in a venue such as a movie theater or a sports stadium.

FIG. 2 is a front perspective view illustrating the protective seat cover, constructed in accordance with the present invention, installed on the chair seat in a venue such as a movie theater or a sports stadium.

FIG. 3 is a side perspective view illustrating the protective seat cover, constructed in accordance with the present invention, installed on the chair seat in a venue such as a movie theater or a sports stadium.

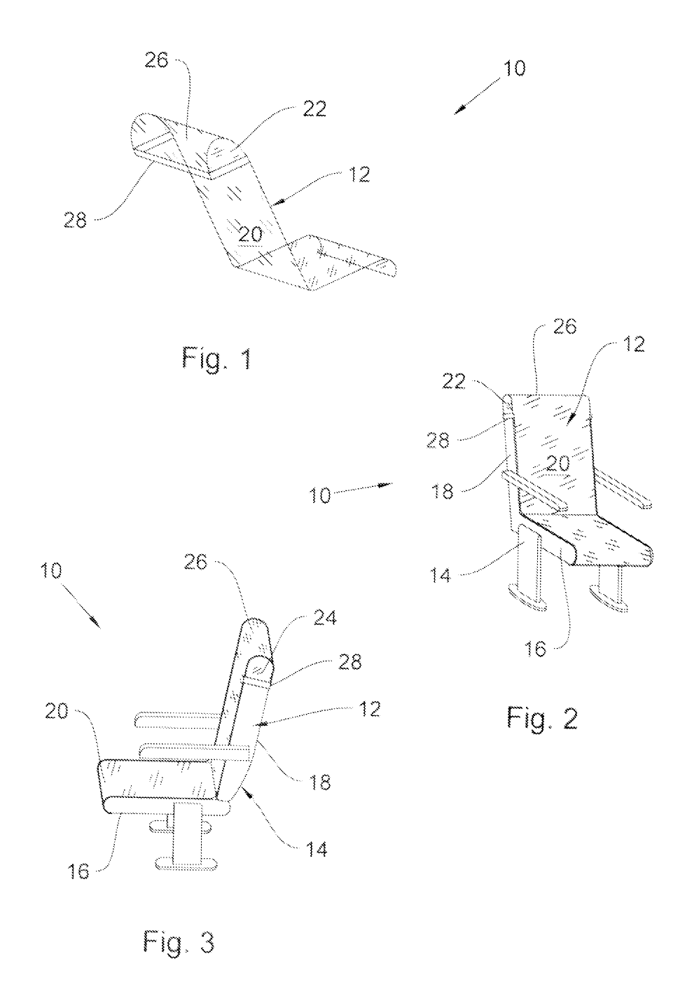

### DETAILED DESCRIPTION OF THE INVENTION

The present invention is a Protective Seat Cover, indicated generally at 10, providing is a disposable protective plastic covering 12 configured particularly for use on public seating such as chair seats 14 found on airplanes, buses, movie theaters, concert venues, and sports arenas, for example. The chair seat 14 has a substantially horizontal seat section 16 with a front edge and a back edge and a substantially vertical backrest section 18 with a top edge and a bottom edge. The backrest section 18 rises from the seat section 16 with the bottom edge of the backrest section 18 positioned adjacent the back edge of the seat section 16. The Protective Seat Cover 10 provides individuals with a reliable barrier between themselves and a potentially contaminated or dirty public chair seat 14.

The Protective Seat Cover 10 of the present invention includes a sheet of disposable impervious material 20 of lightweight, yet durable plastic. Generally rectangular in shape and cut to encompass the surface of standard transportation and stationary chair seating 14 completely, the sheet 20 of the Protective Seat Cover 10 has a top surface, a bottom surface opposite the top side, a top edge, a bottom edge opposite the top edge, a first side edge between the top edge and the bottom edge, and a second side edge opposite the first side edge. The sheet 20 is positionable on the chair seating 14 with the bottom surface positioned in a generally downward direction directly against the chair seating 14 with the top surface positioned in a generally upward direction. Preferably, the bottom edge of the sheet 20 extends and drapes down below the front edge of the seat section 16 of the chair seating 14, protecting a user's legs from making direct contact with a front area of the chair seating 14.

In addition, the Protective Seat Cover 10 of the present invention includes a first side portion 22 secured along the first side edge of the sheet 20 nearingly adjacent the top edge and a second side portion 24 secured along the second side edge of the sheet 20 nearingly adjacent the top edge. The first side portion 22 and the second side portion 24 form a seat receiving pocket 26 in the sheet 20 sized and shaped for receiving and encompassing at least a portion of the top edge of the backrest section 18 of the chair seating 14. The sheet 20 of the Protective Seat Cover 10 is foldable into a compact square or rectangle and can easily be carried in a purse, briefcase, or pocket.

In an embodiment of the Protective Seat Cover 10 of the present invention, an elastic band 28 or segment positioned from the first side edge of the sheet 20, along an edge of the first side portion 22, around the top edge, along an edge of the second side portion 24, and ending at the second edge of the sheet 20. The elastic band 28 assists in releasably securing the sheet 20 of the Protective Seat Cover 10 in place on the chair seating 14 to inhibit the sheet 20 from moving or becoming dislodged from the chair seating 14.

Furthermore, the Protective Seat Cover 10 of the present invention includes a plurality of alcohol swabs for use in wiping down the chair seating's arm rests and tray table. In a preferred embodiment, for use with each Protective Seat Cover 10 are approximately two individually wrapped alcohol cleansing wipes that are utilized to clean and sterilize the chair seat's arm rests and any included tray table.

The Protective Seat Cover 10 of the present invention provides individuals with a sensible solution to problems associated with riding on public transportation. A lightweight yet reliable protective covering that is easily applied to any bus train, or airplane seat, the Protective Seat Cover 10 is an impenetrable barrier between a user and a contaminated seat. Sparing the user distress associated with sitting in a seat sullied by dirt, grime, and trace residue of saliva, urine, or feces, the Protective Seat Cover 10 effectively protects health and wellbeing of a passenger. The Protective Seat Cover 10 eliminates any need to sit directly atop a public seat. The Protective Seat Cover 10 protects clothing and accessories from becoming sullied and stained as a result of sitting on a dirty seat cushion. The Protective Seat Cover 10 protects riders from microorganisms that flourish on a public seat and cause communicable illnesses.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A protective seat cover for covering a chair seat, the chair seat has a substantially horizontal seat section with a front edge and a back edge and a substantially vertical backrest section with a top edge and a bottom edge, the backrest section rises from the seat section with the bottom edge of the backrest section positioned adjacent the back edge of the seat section, the protective seat cover comprising:
a germ impervious sheet of material having a top surface, a bottom surface opposite the top side, a top edge, a bottom edge opposite the top edge, a first side edge between the top edge and the bottom edge, and a second side edge opposite the first side edge; and
a seat receiving pocket formed at the top edge of the sheet of material;
wherein the seat receiving pocket is sized and shaped for receiving and encompassing at least a portion of the top edge of the backrest of the chair seating; and
wherein the sheet of material is positionable on the chair seating with the bottom surface positioned in a generally downward direction directly against the chair seating and the top surface positioned in a generally upward direction providing a barrier for a contaminated or dirty chair seat.

2. The protective seat cover of claim 1 wherein the sheet of material is constructed from a disposable, plastic material.

3. The protective seat cover of claim 1 is substantially rectangular in shape.

4. The protective seat cover of claim 1 wherein the bottom edge of the sheet of material extends and drapes down below the front edge of the seat section of the chair seating.

5. The protective seat cover of claim 1 wherein the seat receiving pocket includes a first side portion secured along the first side edge nearingly adjacent the top edge and a second side portion secured along the second side edge nearingly adjacent the top edge.

6. The protective seat cover of claim 1 wherein the sheet of material is foldable into a compact square or rectangle.

7. The protective seat cover of claim 1 and further comprising:
an elastic band for releasably securing the sheet of material to the chair seating thereby inhibiting the sheet of material from moving or becoming dislodged from the chair seating.

8. The protective seat cover of claim 7 wherein the elastic band is positioned from the first side edge, around the seat receiving pocket, and ending at the second edge.

9. The protective seat cover of claim 1 and further comprising:
a plurality of alcohol swabs.

10. A method for covering a chair seat, the chair seat has a substantially horizontal seat section with a front edge and a back edge and a substantially vertical backrest section with a top edge and a bottom edge, the backrest section rises from the seat section with the bottom edge of the backrest section positioned adjacent the back edge of the seat section, the method comprising:
providing a germ impervious sheet of material having a top surface, a bottom surface opposite the top side, a top edge, a bottom edge opposite the top edge, a first side edge between the top edge and the bottom edge, and a second side edge opposite the first side edge;
forming a seat receiving pocket at the top edge of the sheet of material;
positioning the sheet of material on the chair seating with the bottom surface positioned in a generally downward direction directly against the chair seating and the top surface positioned in a generally upward direction;
encompassing at least a portion of the top edge of the backrest of the chair seating with the seat receiving pocket, and
providing a barrier for a contaminated or dirty chair seat.

11. A protective seat cover for covering a chair seat, the chair seat has a substantially horizontal seat section with a front edge and a back edge and a substantially vertical backrest section with a top edge and a bottom edge, the backrest section rises from the seat section with the bottom edge of the backrest section positioned adjacent the back edge of the seat section, the protective seat cover comprising:
a germ impervious sheet of material having a top surface, a bottom surface opposite the top side, a top edge, a bottom edge opposite the top edge, a first side edge between the top edge and the bottom edge, and a second side edge opposite the first side edge;
a seat receiving pocket formed at the top edge of the sheet of material, the seat receiving pocket having a first side portion secured along the first side edge nearingly adjacent the top edge and a second side portion secured along the second side edge nearingly adjacent the top edge, the seat receiving pocket being sized and shaped for receiving and encompassing at least a portion of the top edge of the backrest of the chair seating; and
an elastic band for releasably securing the sheet of material to the chair seating thereby inhibiting the sheet of material from moving or becoming dislodged from the chair seating;
wherein the sheet of material is positionable on the chair seating with the bottom surface positioned in a generally downward direction directly against the chair seating and the top surface positioned in a generally upward direction providing a barrier or a contaminated or dirty chair seat.

12. The protective seat cover of claim 11 wherein the sheet of material is constructed from a disposable, plastic material.

13. The protective seat cover of claim 11 is substantially rectangular in shape.

14. The protective seat cover of claim 11 wherein the bottom edge of the sheet of material extends and drapes down below the front edge of the seat section of the chair seating.

15. The protective seat cover of claim 11 wherein the sheet of material is foldable into a compact square or rectangle.

16. The protective seat cover of claim 11 wherein the elastic band is positioned from the first side edge of the sheet of material, along an edge of the first side portion, around the top edge, along an edge of the second side portion, and ending at the second edge.

17. The protective seat cover of claim 11 and further comprising:
a plurality of alcohol swabs.
